(19) United States
(12) Patent Application Publication
(10) Pub. No.: US 2025/0156995 A1
(43) Pub. Date: May 15, 2025

(54) REFERENCE PICTURE RESAMPLING (RPR) BASED SUPER-RESOLUTION GUIDED BY PARTITION INFORMATION

(71) Applicant: GUANGDONG OPPO MOBILE TELECOMMUNICATIONS CORP., LTD., Dongguan (CN)

(72) Inventors: Cheolkon JUNG, Dongguan (CN); Qihui HAN, Dongguan (CN)

(21) Appl. No.: 19/003,957

(22) Filed: Dec. 27, 2024

Related U.S. Application Data
(63) Continuation of application No. PCT/CN2022/113423, filed on Aug. 18, 2022.

(30) Foreign Application Priority Data
Jul. 6, 2022 (WO) PCT/CN2022/104245

(51) Int. Cl. G06T 3/4053; G06T 3/4046; G06T 5/50; G06V 10/40

(52) U.S. Cl. CPC G06T 3/4053; G06T 3/4046; G06T 5/50; G06V 10/40; G06T 2207/20084

(57) ABSTRACT

A method for video processing applied to a decoder includes (i) receiving an input image; (ii) processing the input image by one or more convolution layers; (iii) processing the input image by multiple residual blocks by using partition information of the input image as reference so as to obtain reference information features; (iv) generating different-scales features based on the reference information features; (v) processing the different-scales features by multiple convolutional layer sets; (vi) processing the different-scales features by reference spatial attention blocks (RSABs) so as to form a combined feature; and (vii) concatenating the combined feature with the reference information features so as to form an output image.

### CROSS-REFERENCE TO RELATED APPLICATIONS

This application is a continuation of International Application No. PCT/CN2022/113423 filed on Aug. 18, 2022, which claims the benefit of priority to International Application No. PCT/CN2022/104245 filed on Jul. 6, 2022, both of which are incorporated herein by reference in their entireties.

### TECHNICAL FIELD

This present disclosure relates to image processing. For example, the present disclosure includes video compression schemes that can improve video reconstruction performance and efficiency. More specifically, the present disclosure is directed to systems and methods for providing a convolutional neural network filter used for an up-sampling process.

### BACKGROUND

Video coding of high-definition videos has been the focus in the past decade. Although the coding technology has improved, it remains challenging to transmit high-definition videos with limited bandwidth. Approaches coping with this problem include resampling-based video coding, in which (i) an original video is first “down-sampled” before encoding to form an encoded video in the encoder side (the encoder includes a decoder to generate bitstream), (ii) the encoded video is transmitted to the decoder side as bitstream and then the bitstream is decoded in decoder to form a decoded video (the decoder is the same as the decoder included in the encoder); and (iii) then the decoded video is “up-sampled” to the same resolution as the original video. For example, Versatile Video Coding (VVC) supports a resampling-based coding scheme (reference picture resampling, RPR), that a temporal prediction between different resolutions is enabled. However, traditional methods do not handle up-sampling process efficiently especially for videos with complicated characteristics. Therefore, it is advantageous to have an improved system and method to address the foregoing needs.

### SUMMARY

The present disclosure is related to systems and methods for improving image qualities of videos using a neural network for video compression. More particularly, the present disclosure provides attention-based super-resolution (SR) for video compression guided by partition information. In some embodiments, a convolutional neural network (CNN) is combined with an RPR functionality in VVC to achieve super-resolution reconstruction (e.g., removing artifacts). More particularly, the present disclosure utilizes reconstructed frames and up-sampled frames by the RPR functionality as an input and then uses a coding tree unit (CTU) partition information (e.g., CTU partition map) as reference to generate spatial attention information for removing artifact.

In some embodiments, considering the correlation between luma and chrominance components, features are extracted by three branches for the luma and chroma components. The extracted features are then concatenated and fed into a “U-net” structure. Then SR reconstruction results are generated by three reconstruction branches.

In some embodiments, the “U-Net” structure includes multiple stacked attention blocks (e.g., Dilated-convolutional-layers-based Dense Block with Channel Attention, DDBCA). The “U-Net” structure is configured to effectively extract low-level features and then transfer the extracted low-level features to a high-level feature extraction module (e.g., through skipping connections in the U-Net structure). High-level features contain global semantic information, whereas low-level features contain local detail information. The U-Net connections can further reuse low-level features while restoring local details.

One aspect the present disclosure is that it only utilizes partition information as reference (see e.g., FIG. 2), rather than as input, when processing images/videos. By this arrangement, the present disclosure can effectively incorporate the features affected by the partition information, without excessively adding undesirable negative impact from direct inputting the partition information to the images/videos.

Another aspect of the present disclosure is that it processes luma component and chroma components at the same time, while using partition information as reference. As discussed herein (see e.g., FIG. 2), the present disclosure provides a framework or network that can process the luma component and the chroma components at the same time with attention to the partition information.

Another aspect of the present disclosure is that it provides an efficient coding strategy based on resampling. The present system and methods can effectively reduce transmission bandwidth so as to avoid or mitigate degradation of video quality.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings.

FIG. 1 is a schematic diagram illustrating an up-sampling process in resampling-based video coding in accordance with one or more implementations of the present disclosure.

FIG. 2 is a schematic diagram illustrating an RPR-based super-resolution (SR) framework (i.e. the CNN filter in the up-sampling process) in accordance with one or more implementations of the present disclosure.

FIG. 3 is a schematic diagram illustrating a reference spatial attention block (RSAB) in accordance with one or more implementations of the present disclosure.

FIG. 4 is a schematic diagram illustrating a Dilated-convolutional-layers-based Dense Block with Channel Attention (DDBCA) in accordance with one or more implementations of the present disclosure.

FIGS. 5A-5E are images illustrating testing results in accordance with one or more implementations of the present disclosure.

FIG. 6 and FIG. 7 are testing results of the framework in accordance with one or more implementations of the present disclosure.

FIG. 8 is a schematic diagram of a wireless communication system in accordance with one or more implementations of the present disclosure.

FIG. 9 is a schematic block diagram of a terminal device in accordance with one or more implementations of the present disclosure.

FIG. 10 is a schematic block diagram of a device in accordance with one or more implementations of the present disclosure.

FIG. 11 is a flowchart of a method in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings.

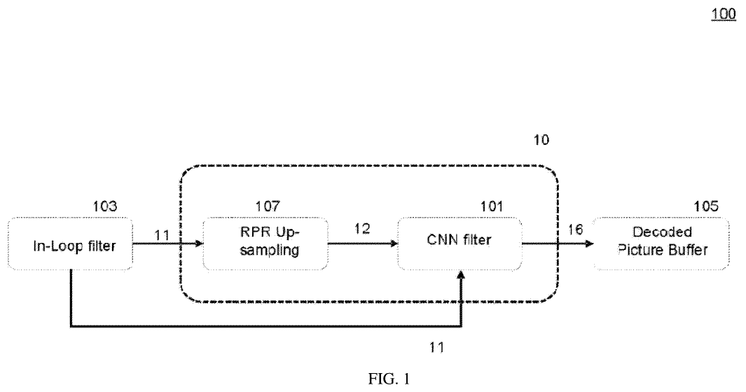

FIG. 1 is a schematic diagram illustrating an up-sampling process in resampling-based video coding 100 in accordance with one or more implementations of the present disclosure. To implement an RPR functionality in resampling-based video coding, a current frame for encoding is first down-sampled to reduce bitstream transmission and then is restored at the decoding end. The current frame is to be up-sampled to its original resolution. The up-sampling process 100 includes an SR neural network to replace a traditional up-sampling algorithm in a traditional RPR configuration. The up-sampling process 100 can include a CNN filter 101 with a dilated-convolutional-layers-based dense block with an attention mechanism. The up-sampling process 100 uses residual learning to reduce the complexity of network learning so as to improve performance and efficiency.

As shown in FIG. 1, images can be sent for an up-sampling process 10 from an in-loop filter 103. In some implementations, the in-loop filter 103 can be applied in encoding and decoding loops, after an inverse quantization process and before storing processed images in a decoded picture buffer 105. In the up-sampling process 10, an RPR up-sampling module 107 receives images 11 from the in-loop filter 103, and then generates up-sampled frames 12 and transmits the same to the CNN filter 101. The in-loop filter 103 also sends reconstructed frames 11 to the CNN filter 101. The CNN filter 101 then processes the up-sampled frames 12 and the reconstructed frames 11 and sends processed images 16 to the decoded picture buffer 105 for further processes (e.g., to generate decoded video sequences).

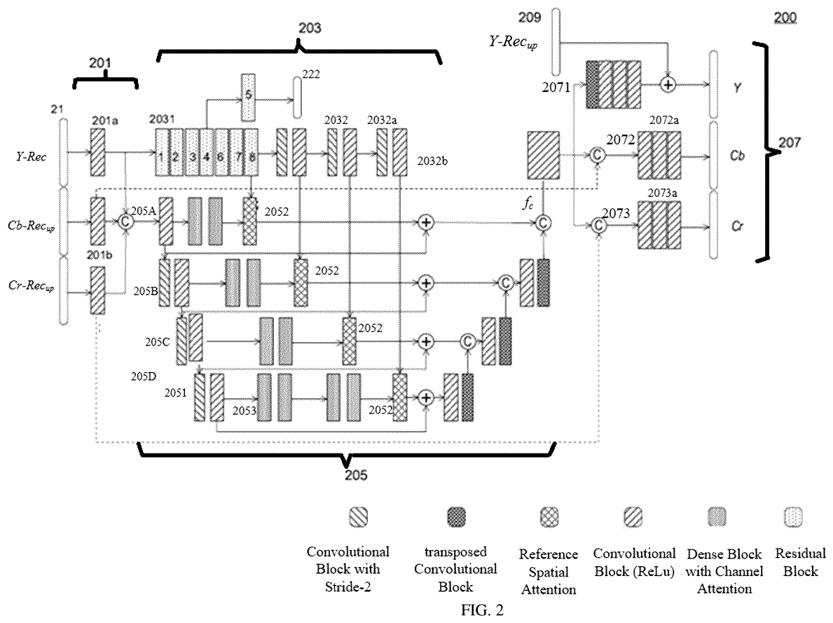

FIG. 2 is a schematic diagram illustrating a framework 200 for RPR-based SR guided by partition information. As shown in FIG. 2, the framework 200 includes four parts: a feature extraction part 201, a reference information generation (RIG) part 203, a mutual information processing part 205, and a reconstruction part 207. The framework 200 uses partition information 222 as reference (rather than an input) when processing videos/images. As described in detail below, the partition information 222 is used in the RIG part 203 (e.g., via residual blocks 2031) and the mutual information processing part 205 (e.g., via reference feature attention module 2052). Please note that these parts are described separately for the ease of reference, and these parts can function collectively when processing.

The feature extraction part 201 includes of three convolutional layers (201a-c). The convolutional layers 201a-c are used to extract features of inputs 21 (e.g., luma component “Y” and chroma components “Cb” and “Cr”). The convolutional layers 201a-c are followed by an ReLU (Rectified Linear Unit) activation function. In some embodiments, the inputs can be reconstructed frames after an RPR up-sampling process. In some embodiments, the inputs can include luma component and/or chroma components.

In some embodiments, assuming that inputs Y_{Rec}, Cb_{Rec}^{Up} and Cr_{Rec}^{Up} are through feature extraction layers “cy1,” “cb1” and “cr1,” extracted features f₁^{y}, f₁^{cb} and f₁^{cr} can be represented as follows.

$${f}_{1}^{y} = {cy}_{1} ( {Y}_{Rec} ) \qquad Equation ( 1 )$$

$${f}_{1}^{cb} = {cb}_{1} ( {Cb}_{Rec}^{Up} ) \qquad Equation ( 2 )$$

$${f}_{1}^{cr} = {cr}_{1} ( {Cr}_{Rec}^{Up} ) \qquad Equation ( 3 )$$

The reference information generation (RIG) part 203 includes eight residual blocks 2031 (noted as No. 1, 2, 3, 4, 5, 6, 7, and 8 in FIG. 2). The first four residual blocks 2031 (e.g., No. 1, 2, 3, and 4) are performed for predicting CTU partition information from a reconstructed frame of input 21. A reference residual block (e.g., No. 5) is generated and used to incorporate the partition information 222. The following three residual blocks 2031 (e.g., No. 6, 7, and 8) are used for reference information generation.

Sequentially, reference information features can be used as input of several convolutional layer sets 2032 to generate different-scales features, which can be used as input of a reference feature attention module (e.g., a reference spatial attention blocks 2052, as discussed below). Each of the convolutional layer sets 2032 can include a convolutional layer with stride 2 (noted as 2032a in FIG. 2) and a convolutional layer followed by an ReLU (noted as 2032b in FIG. 2). Accordingly, the output of the RIG part 203 can be represented as follows:

$${f}_{r}^{1} , {f}_{r}^{1 / 2} , {f}_{r}^{1 / 4} , {f}_{r}^{1 / 8} = RIG ( {f}_{1}^{y} ) \qquad Equation ( 4 )$$

The mutual information processing (MIP) part 205 is based on a U-Net backbone. Inputs of the MIP part 205 can be the reference features fᵣ and the concatenates of f₁^{y}, f₁^{cb} and f₁^{cr}.

The MIP part 205 includes convolutional layers 2051, reference spatial attention blocks (RSAB) 2052, and dilated convolutional layers based dense blocks with channel attention (DDBCAs) 2053.

As shown in the FIG. 2, there are four different scales 205 A-D (e.g., four horizontal branches below the RIG part 203) in the MIP part 205. The first three scales (e.g., from the top, 205A-C) utilize two DDBCAs 2053 followed by one RSAB 2052, whereas the last scale (e.g., at the bottom, 205D) utilizes four DDBCAs 2053 followed by one RSAB 2052. Finally, the combined feature fc is generated by reconstructing the multi-scale features as follows:

$${f}_{c} = MIP ( {f}_{r}^{1} , {f}_{r}^{1 / 2} , {f}_{r}^{1 / 4} , {f}_{r}^{1 / 8} , {f}_{1}^{y} , {f}_{1}^{cb} , {f}_{1}^{cr} ) \qquad Equation ( 5 )$$

The reconstruction part 207 includes three branch paths for processing luma and chroma components. In some embodiments, for a luma channel (path 2071), the combined feature fc is up-sampled and put to three convolutional layers 2071a followed by an addition operation 2071b with a reconstructed luma component 209 after an RPR up-sampling process.

In some embodiments, for chroma channels (e.g., paths 2072, 2073), the combined feature fc is concatenated with the extracted features f₁^{cb} and f₁^{cr} and then input to three convolutional layers 2072a, 2073a. The final outputs are generated as follows:

$$Y = Convs ( {f}_{c} ) + {Y}_{Rec}^{Up} \qquad Equation ( 6 )$$

$$Cb = Convs ( {f}_{c} , {f}_{1}^{cb} ) \qquad Equation ( 7 )$$

$$Cr = Convs ( {f}_{c} , {f}_{1}^{cr} ) \qquad Equation ( 8 )$$

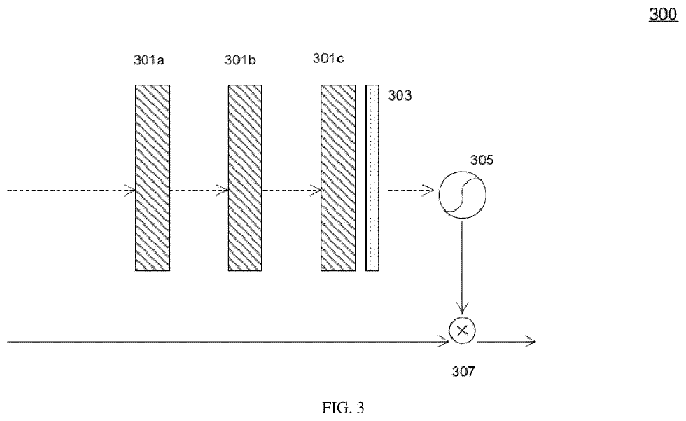

FIG. 3 is a schematic diagram illustrating a reference spatial attention block (RSAB) 300 in accordance with one or more implementations of the present disclosure. Blocking artifact shown in decoding are closely related to block partitioning. Therefore, a CTU partition map is suitable as auxiliary information to predict blocking artifacts. When a partition map is directly used as an input, the block artifacts of the partition map can cause a negative impact on super-resolution. Therefore, the present disclosure uses the RSAB 300 to guide an image deblocking process by analyzing CTU partition information in the CTU partition map.

As shown in FIG. 3, the RSAB 300 includes three convolutional layers 301a-c followed by a ReLU function 303 and a Sigmoid function 305. The reference features (e.g., those discussed with reference to FIG. 2) are put to the convolutional layers 301a-c, the ReLU function 303, and the Sigmoid function 305 sequentially. Finally, the input features are multiplied (e.g., at 307) by the processed reference features. The “dashed line” (upper portion of FIG. 3) indicates that the partition information is only used as reference, rather than input, as compared to the main processing stream (solid line at the lower portion of FIG. 3).

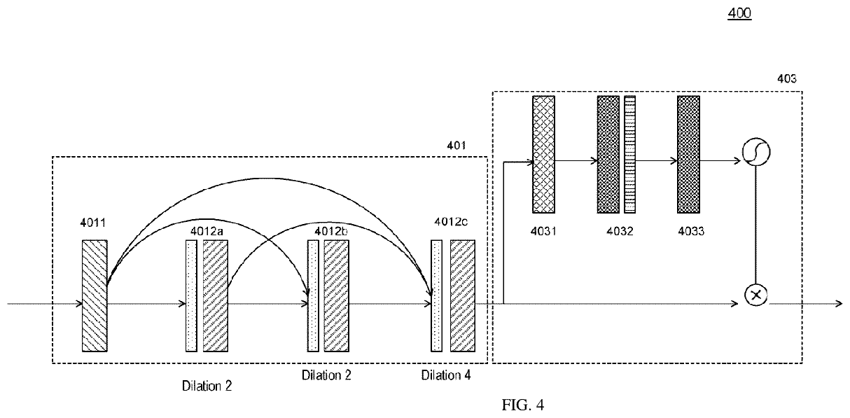

To reduce the number of parameters and expand the receptive field of an image, the present disclosure integrates dilated convolution layers and channel attention module into a “dense block” as shown in FIG. 4. FIG. 4 is a schematic diagram illustrating a Dilated-convolutional-layers-based Dense Block with Channel Attention (DDBCA) 400 in accordance with one or more implementations of the present disclosure. The DDBCA 400 includes a dilated convolution based dense module 401 and an optimized channel attention module 403.

In some embodiments, the dilated convolution based dense module 401 includes one convolutional layer 4011 and three dilated convolutional layers 4012. The three dilated convolutional layers 4012 include layer 4012a (with dilation factor 2), 4012b (with dilation factor 2), and 4012c (with dilation factor 4). By this arrangement, the receptive field of the dilated convolution based dense module 401 is larger than the receptive filed of normal convolutional layers.

In some embodiments, the optimized channel attention module 403 is configured to perform a Squeeze and Excitation (SE) attention mechanism so it can be called SE attention module. The optimized channel attention module 403 is configured to boost the nonlinear relationship between input feature channels compared to ordinary channel attention modules. The optimized channel attention module 403 is configured to perform three steps, including a “squeeze” step, an “excitation” step, and a “scale” step.

Squeeze Step (4031): First, a global average pooling on an input feature map is performed to obtain f_{sq}. Each of the learned filters operates with a local receptive field and consequently each unit of the transformation output is unable to exploit contextual information outside of this region. To mitigate this problem, the SE attention mechanism first “squeezes” global spatial information into a channel descriptor. This is achieved by a global average pooling to generate channel-wise statistics.

Excitation Step (4033): This step is motivated to better obtain the dependency of each channel. Two conditions need to be met: the first condition is that the nonlinear relationship between each channel can be learned, and the second condition is that each channel has an output (e.g., the value cannot be 0). An activation function in the illustrated embodiments can be “sigmoid” instead of the commonly used ReLU. The excitation process is that f_{sq} passes through two fully connected layers to compress and restore the channel. In image processing, to avoid the conversion between matrices and vectors, 1×1 convolution layer is used instead of using a fully connected layer.

Scale: Finally, a dot product is performed between the output after excitation and SE attention. By this arrangement, intrinsic relationships of features using the adaptive channel weight maps can be established.

In some embodiments, L1 or L2 loss can be used to train the proposed framework discussed herein. The loss function f(x) can be expressed as follows:

$$Loss = \frac{1}{N} ( {\sum }_{x} \vert y ( x ) - \hat{y} ( x ) \vert + α * \frac{epoch}{epochs} * {\sum }_{x} {‖ y ( x ) - \hat{y} ( x ) ‖}^{2} ) \qquad Equation ( 9 )$$

Where “α” is a coefficient to balance the L1 and L2 loss, “epochs” is the total epoch number of training process and “epoch” is a current index. At the beginning of training, L1 loss has a larger weight to speed up the convergence, whereas in the second half of training, L2 loss plays an important role to generate better results. In some embodiments, the L1 or L2 loss is a loss function that is compared at the pixel level. The L1 loss calculates the sum of the absolute values of the difference between the output and the ground truth, whereas the L2 loss calculates the sum of the squares of the difference between the output and the ground truth.

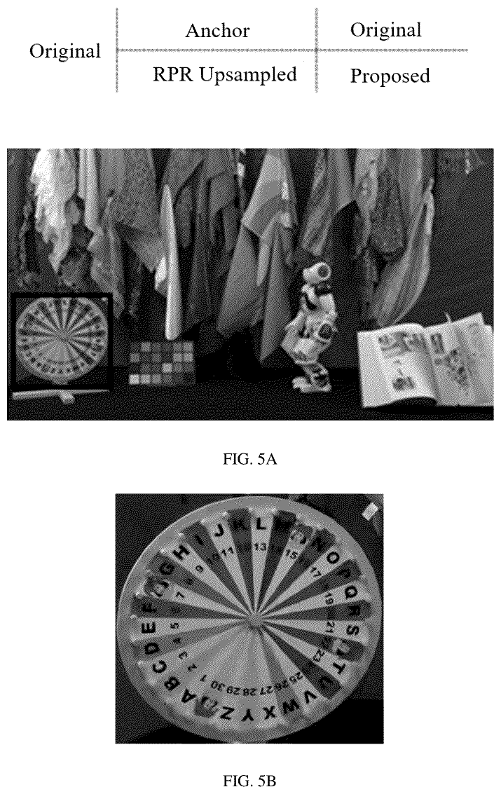

FIGS. 5A-5E (i.e., “CatRobots”) are images illustrating testing results in accordance with one or more implementations of the present disclosure. Descriptions of the images are as follows: (a) an original image; (b) a processed image under an existing standard (VTM 11.0 NNVC-1.0, noted as “anchor”); (c) a portion of the original image to be compared; (d) a processed image with the RPR process; and (e) an image processed by the framework discussed herein. As can be seen and support by the testing result below, the present framework (i.e., (e)) provides better image quality effectively, as compared to existing methods (i.e., (b) and (d)).

Table 1 below shows quantitative measurements of the use of the present framework. The test results under “all intra” (AI) configurations. Among them, “bold numbers” represent positive gain and “underlined” numbers represents negative gain. These tests are all conducted under “CTC.” “VTM-11.0” with new “MCTF” are used as the baseline for tests. Table 1 show the results in comparison with VTM 11.0 NNVC-1.0 anchor. The present framework achieves {-9.25%, 8.82%, −16.39%} BD-rate reductions under the AI configurations.

| | | All Intra Main10 | | | | |
|---|---|---|---|---|---|---|
| | | Over VTM-11.0 + New MCTF | | | | |
| | | (QP 22, 27, 32, 37, 42) | | | | |
| | | Y | U | V | EncT | DecT |
| Cass | Tango2 | −9.18% | −13.60% | −13.82% | | |
| A1 | FoodMarket4 | −3.74% | −0.86% | −2.87% | | |
| 4K | Campfire | −15.40% | 119.65% | −26.68% | | |
| Class | CatRobot1 | −8.34% | −11.08% | −10.88% | | |
| A2 | DaylightRoad2 | −2.79% | −24.23% | −22.67% | | |
| 4K | ParkRunning3 | −16.02% | −16.98% | −21.40% | | |

| | | | |
|---|---|---|---|
| Average on A1 | −9.44% | 35.06% | −14.46% |
| Average on A2 | −9.05% | −17.43% | −18.32% |
| Overall | −9.25% | 8.82% | −16.39% |

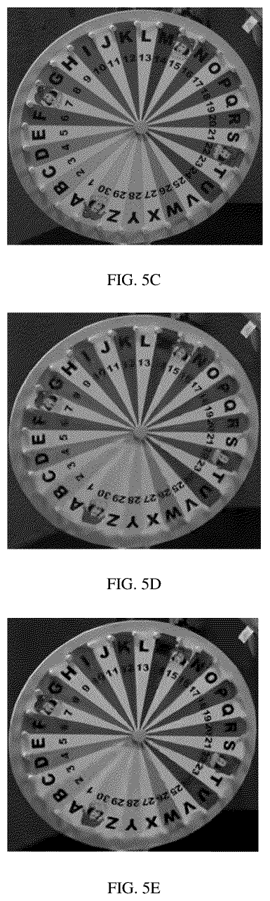

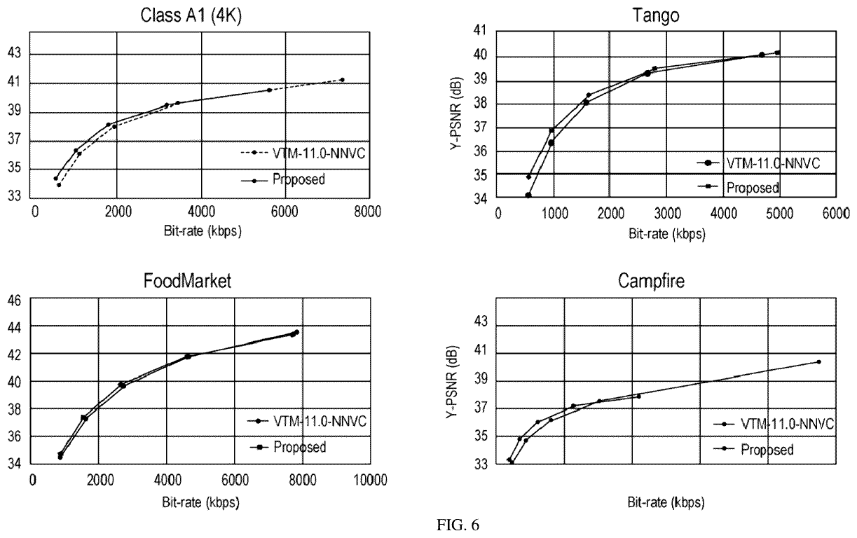

FIG. 6 and FIG. 7 are testing results of the framework in accordance with one or more implementations of the present disclosure. FIG. 6 and FIG. 7 use rate distortion (RD) curves to demonstrate the testing result. “A” stands for the average of different groups (A1 and A2). The RD curve of the A1 and A2 sequences are presented in FIG. 6 and FIG. 7. As shown, the present framework (noted as “proposed”) achieves remarkable gains all of the A1 and A2 sequences. Among them, all the RD curves of the present framework exceed those of VTM-11.0 in a lower bitrate region (i.e., the left of the curves), which indicates that the proposed framework is more efficient at a low bandwidth.

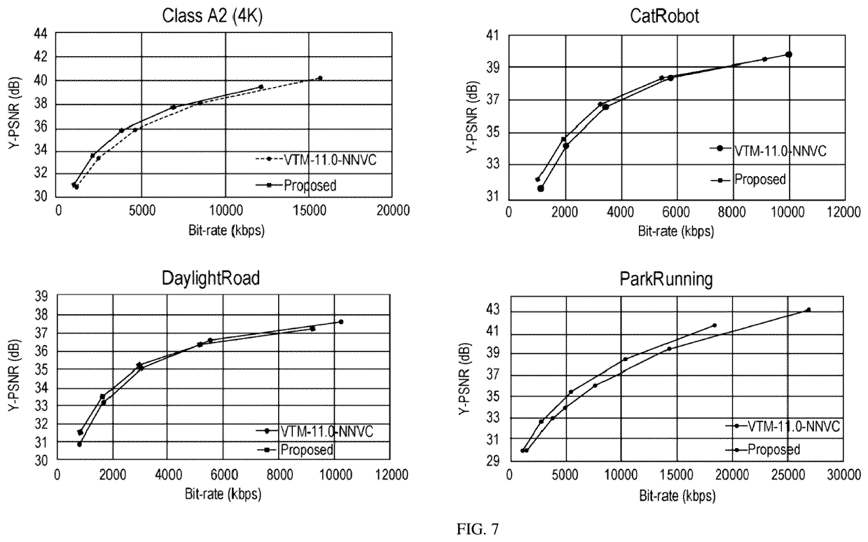

FIG. 8 is a schematic diagram of a wireless communication system 800 in accordance with one or more implementations of the present disclosure. The wireless communication system 800 can implement the framework discussed herein. As shown in FIG. 8, the wireless communications system 800 can include a network device (or base station) 801. Examples of the network device 801 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 801 can include a relay station, an access point, an in-vehicle device, a wearable device, and the like. The network device 801 can include wireless connection devices for communication networks such as: a Global System for Mobile Communications (GSM) network, a Code Division Multiple Access (CDMA) network, a Wideband CDMA (WCDMA) network, an LTE network, a cloud radio access network (CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 8, the wireless communications system 800 also includes a terminal device 803. The terminal device 803 can be an end-user device configured to facilitate wireless communication. The terminal device 803 can be configured to wirelessly connect to the network device 801 (via, e.g., via a wireless channel 805) according to one or more corresponding communication protocols/standards. The terminal device 803 may be mobile or fixed. The terminal device 803 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 803 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 8 illustrates only one network device 801 and one terminal device 803 in the wireless communications system 800. However, in some instances, the wireless communications system 800 can include additional network device 801 and/or terminal device 803.

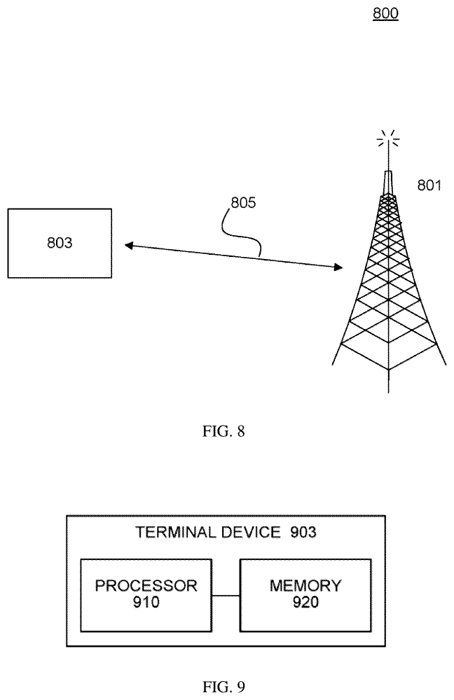

FIG. 9 is a schematic block diagram of a terminal device 903 (e.g., which can implement the methods discussed herein) in accordance with one or more implementations of the present disclosure. As shown, the terminal device 903 includes a processing unit 910 (e.g., a DSP, a CPU, a GPU, etc.) and a memory 920. The processing unit 910 can be configured to implement instructions that correspond to the methods discussed herein and/or other aspects of the implementations described above. It should be understood that the processor 910 in the implementations of this technology may be an integrated circuit chip and has a signal processing capability. During implementation, the steps in the foregoing method may be implemented by using an integrated logic circuit of hardware in the processor 910 or an instruction in the form of software. The processor 910 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 910 may be a microprocessor, or the processor 910 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature non-transitory storage medium in this field. The non-transitory storage medium is located at a memory 920, and the processor 910 reads information in the memory 920 and completes the steps in the foregoing methods in combination with the hardware thereof.

It may be understood that the memory 920 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

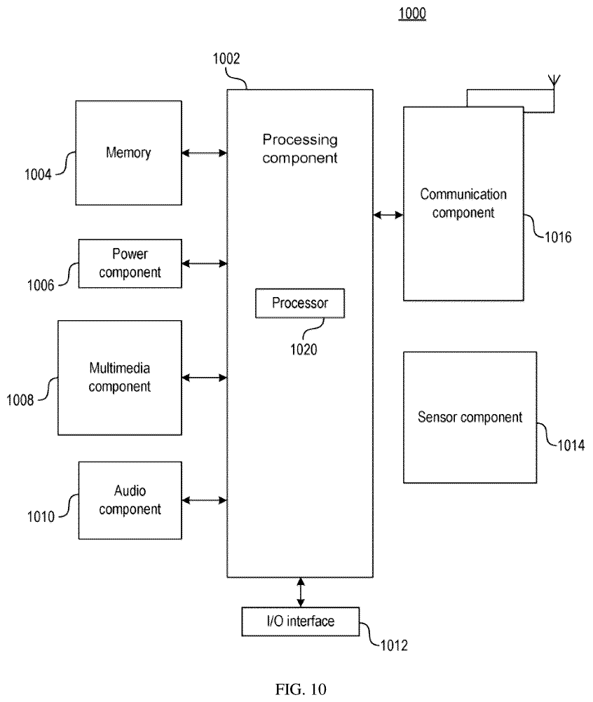

FIG. 10 is a schematic block diagram of a device 1000 in accordance with one or more implementations of the present disclosure. The device 1000 may include one or more of the following components: a processing component 1002, a memory 1004, a power component 1006, a multimedia component 1008, an audio component 1010, an Input/Output (I/O) interface 1012, a sensor component 1014, and a communication component 1016.

The processing component 1002 typically controls overall operations of the electronic device, such as the operations associated with display, telephone calls, data communications, camera operations, and recording operations. The processing component 1002 may include one or more processors 1020 to execute instructions to perform all or part of the steps in the abovementioned method. Moreover, the processing component 1002 may include one or more modules which facilitate interaction between the processing component 1002 and the other components. For instance, the processing component 1002 may include a multimedia module to facilitate interaction between the multimedia component 1008 and the processing component 1002.

The memory 1004 is configured to store various types of data to support the operation of the electronic device. Examples of such data include instructions for any application programs or methods operated on the electronic device, contact data, phonebook data, messages, pictures, video, etc. The memory 1004 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 1006 provides power for various components of the electronic device. The power component 1006 may include a power management system, one or more power supplies, and other components associated with generation, management and distribution of power for the electronic device.

The multimedia component 1008 may include a screen providing an output interface between the electronic device and a user. In some embodiments, the screen may include a Liquid Crystal Display (LCD) and a Touch Panel (TP). If the screen may include the TP, the screen may be implemented as a touch screen to receive an input signal from the user. The TP may include one or more touch sensors to sense touches, swipes and gestures on the TP. The touch sensors may not only sense a boundary of a touch or swipe action but also detect a duration and pressure associated with the touch or swipe action. In some embodiments, the multimedia component 1008 may include a front camera and/or a rear camera. The front camera and/or the rear camera may receive external multimedia data when the electronic device is in an operation mode, such as a photographing mode or a video mode. Each of the front camera and the rear camera may be a fixed optical lens system or have focusing and optical zooming capabilities.

The audio component 1010 is configured to output and/or input an audio signal. For example, the audio component 1010 may include a Microphone (MIC), and the MIC is configured to receive an external audio signal when the electronic device is in the operation mode, such as a call mode, a recording mode and a voice recognition mode. The received audio signal may further be stored in the memory 1004 or sent through the communication component 1016. In some embodiments, the audio component 1010 further may include a speaker configured to output the audio signal.

The I/O interface 1012 provides an interface between the processing component 1002 and a peripheral interface module, and the peripheral interface module may be a keyboard, a click wheel, a button and the like. The button may include, but not limited to, a home button, a volume button, a starting button and a locking button.

The sensor component 1014 may include one or more sensors configured to provide status assessment in various aspects for the electronic device. For instance, the sensor component 1014 may detect an on/off status of the electronic device and relative positioning of components, such as a display and small keyboard of the electronic device, and the sensor component 1014 may further detect a change in a position of the electronic device or a component of the electronic device, presence or absence of contact between the user and the electronic device, orientation or acceleration/deceleration of the electronic device and a change in temperature of the electronic device. The sensor component 1014 may include a proximity sensor configured to detect presence of an object nearby without any physical contact. The sensor component 1014 may also include a light sensor, such as a Complementary Metal Oxide Semiconductor (CMOS) or Charge Coupled Device (CCD) image sensor, configured for use in an imaging application. In some embodiments, the sensor component 1014 may also include an acceleration sensor, a gyroscope sensor, a magnetic sensor, a pressure sensor or a temperature sensor.

The communication component 1016 is configured to facilitate wired or wireless communication between the electronic device and other equipment. The electronic device may access a communication-standard-based wireless network, such as a WIFI network, a 2nd-Generation (2G) or 3G network or a combination thereof. In an exemplary embodiment, the communication component 1016 receives a broadcast signal or broadcast associated information from an external broadcast management system through a broadcast channel. In an exemplary embodiment, the communication component 1016 further may include a Near Field Communication (NFC) module to facilitate short-range communication. For example, the NFC module may be implemented on the basis of a Radio Frequency Identification (RFID) technology, an Infrared Data Association (IrDA) technology, an Ultra-Wide Band (UWB) technology, a BT technology and another technology.

In an exemplary embodiment, the electronic device may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 1004 including an instruction, and the instruction may be executed by the processor 1002 of the electronic device to implement the abovementioned method. For example, the non-transitory computer-readable storage medium may be a ROM, a Random Access Memory (RAM), a Compact Disc Read-Only Memory (CD-ROM), a magnetic tape, a floppy disc, an optical data storage device and the like.

In a first clause, the present application provides a method for video processing applied to a decoder, and the method includes:
receiving an input image;
processing the input image by one or more convolution layers;
processing the input image by multiple residual blocks by using partition information of the input image as reference so as to obtain reference information features;
generating different-scales features based on the reference information features;
processing the different-scales features by multiple convolutional layer sets;
processing the different-scales features by reference spatial attention blocks (RSABs) so as to form a combined feature; and
concatenating the combined feature with the reference information features so as to form an output image.

In a second clause, according to the first clause, the one or more convolution layers belong to a feature extraction part of a framework.

In a third clause, according to the first clause, the multiple residual blocks belong to a reference information generation (RIG) part of a framework.

In a fourth clause, according to the third clause, the multiple residual blocks include eight residual blocks, and the first four residual blocks are used for predicting coding-tree-unit (CTU) partition information from the one or more convolution layers.

In a fifth clause, according to the fourth clause, the RIG part further includes the multiple convolutional layer sets, and each of the multiple convolutional layer sets includes a convolutional layer with stride 2 and a convolutional layer followed by a rectified linear unit (ReLU).

In a sixth clause, according to the first clause, the method further includes: processing the different-scales features by dilated convolutional layers based dense blocks with channel attention (DDBCAs) so as to form the combined feature.

In a seventh clause, according to the sixth clause, the DDBCAs and the RSABs belong to a mutual information processing (MIP) part of a framework.

In an eighth clause, according to the seventh clause, the MIP part includes four scales configured to generating the different-scales features.

In a ninth clause, according to the eighth clause, at least one of the four scales includes two DDBCAs followed by one RSAB.

In a tenth clause, according to the eighth clause, one of the four scales includes four DDBCAs followed by one RSAB.

In an eleventh clause, according to the first clause, the combined feature is concatenated by a reconstruction part of a framework.

In a twelfth clause, according to the eleventh clause, the reconstruction part includes three branch paths for processing luma and chroma components, respectively.

In a thirteenth clause, the present application provides a system for video processing, and the system includes:
a processor; and
a memory configured to store instructions, the instructions, when executed by the processor, causes the system to implement the method for video processing according to any one of the first clause to the twelfth clause.

In a fourteenth clause, the present application provides a method for video processing applied to an encoder, and the method includes:
receiving an input image;
processing the input image by one or more convolution layers;
processing the input image by multiple residual blocks by using partition information of the input image as reference so as to obtain reference information features;
generating different-scales features based on the reference information features;
processing the different-scales features by multiple convolutional layer sets;
processing the different-scales features by reference spatial attention blocks (RSABs) and dilated convolutional layers based dense blocks with channel attention (DDBCAs) so as to form a combined feature; and
concatenating the combined feature with the reference information features so as to form an output image.

In a fifteenth clause, the present application provides a non-transitory computer storage medium storing a computer program, where when the computer program is executed by a processor, the method for video processing applied to the decoder according to any one of the first clause to the twelfth clause is implemented, or the method for video processing applied to the encoder according the fourteenth clause is implemented.

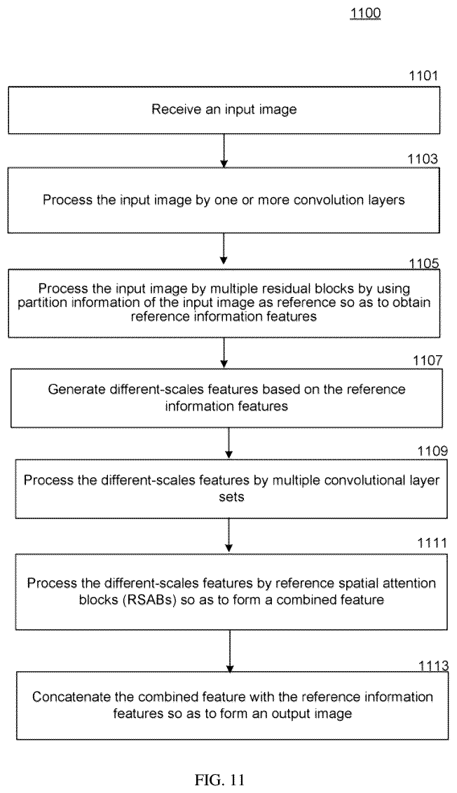

FIG. 11 is a flowchart of a method in accordance with one or more implementations of the present disclosure. The method 1100 can be implemented by a system (such as a system with the framework discussed herein). The method 1100 is for enhancing image qualities (particularly, for an up-sampling process). The method 1100 includes, at block 1101, receiving an input image.

At block 1103, the method 1100 continues by processing the input image by one or more convolution layers. In some embodiments, the one or more convolution layers belong to a feature extraction part (e.g., component 201 of FIG. 2) of a framework.

At block 1105, the method 1100 continues by processing the input image by multiple residual blocks by using partition information (e.g., component 222 of FIG. 2) of the input image as reference so as to obtain reference information features.

In some embodiments, the multiple residual blocks belong to a reference information generation (RIG) part of a framework. The multiple residual blocks can include eight residual blocks. In such embodiments, the first four residual blocks can be used for predicting coding-tree-unit (CTU) partition information from the one or more convolution layers.

At block 1107, the method 1100 continues by generating different-scales features based on the reference information features. At block 1109, the method 1100 continues by processing the different-scales features by multiple convolutional layer sets. At block 1111, the method 1100 continues by processing the different-scales features by reference spatial attention blocks (RSABs) so as to form a combined feature.

In some embodiments, the method 1100 further comprises processing the different-scales features by dilated convolutional layers based dense blocks with channel attention (DDBCAs) so as to form the combined feature. The DDBCAs and the RSABs can belong to a mutual information processing (MIP) part of the framework.

In some embodiments, the MIP part includes four scales configured to generating the different-scales features. In some embodiments, at least one of the four scales includes two DDBCAs followed by one RSAB. In some embodiments, one of the four scales includes four DDBCAs followed by one RSAB.

In some embodiments, the RIG part can further include the multiple convolutional layer sets, and each of the multiple convolutional layer sets includes a convolutional layer with stride 2 and a convolutional layer followed by a rectified linear unit (ReLU).

At block 1113, the method 1100 continues by concatenating the combined feature with the reference information features so as to form an output image. In some embodiments, the combined feature is concatenated by a reconstruction part of a framework. In some embodiments, the reconstruction part includes three branch paths for processing luma and chroma components, respectively.

### ADDITIONAL CONSIDERATIONS

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the disclosure is not limited, except as by the appended claims. In general, the terms used in the following claims should not be construed to limit the disclosed technology to the examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the disclosure are presented below in certain claim forms, the applicant contemplates the various aspects of the disclosure in any number of claim forms. Accordingly, the applicant reserves the right to pursue additional claims after filing this application to pursue such additional claim forms, in either this application or in a continuing application.

What is claimed is:

1. A method for video processing applied to a decoder, the method comprising:
receiving an input image;
processing the input image by one or more convolution layers;
processing the input image by multiple residual blocks by using partition information of the input image as reference so as to obtain reference information features;
generating different-scales features based on the reference information features;
processing the different-scales features by multiple convolutional layer sets;
processing the different-scales features by reference spatial attention blocks (RSABs) so as to form a combined feature; and
concatenating the combined feature with the reference information features so as to form an output image.

2. The method of claim 1, wherein the one or more convolution layers belong to a feature extraction part of a framework.

3. The method of claim 1, wherein the multiple residual blocks belong to a reference information generation (RIG) part of a framework.

4. The method of claim 3, wherein the multiple residual blocks include eight residual blocks, and wherein the first four residual blocks are used for predicting coding-tree-unit (CTU) partition information from the one or more convolution layers.

5. The method of claim 4, wherein the RIG part further includes the multiple convolutional layer sets, and wherein each of the multiple convolutional layer sets includes a convolutional layer with stride 2 and a convolutional layer followed by a rectified linear unit (ReLU).

6. The method of claim 1, further comprising processing the different-scales features by dilated convolutional layers based dense blocks with channel attention (DDBCAs) so as to form the combined feature.

7. The method of claim 6, wherein the DDBCAs and the RSABs belong to a mutual information processing (MIP) part of a framework.

8. The method of claim 7, wherein the MIP part includes four scales configured to generating the different-scales features.

9. The method of claim 8, wherein at least one of the four scales includes two DDBCAs followed by one RSAB.

10. The method of claim 8, wherein one of the four scales includes four DDBCAs followed by one RSAB.

11. The method of claim 1, wherein the combined feature is concatenated by a reconstruction part of a framework.

12. The method of claim 11, wherein the reconstruction part includes three branch paths for processing luma and chroma components, respectively.

13. A system for video processing, the system comprising:
a processor; and
a memory configured to store instructions, when executed by the processor, to:
receive an input image;
process the input image by one or more convolution layers;
process the input image by multiple residual blocks by using partition information of the input image as reference so as to obtain reference information features;
generate different-scales features based on the reference information features;
process the different-scales features by multiple convolutional layer sets;
process the different-scales features by reference spatial attention blocks (RSABs) so as to form a combined feature; and
concatenate the combined feature with the reference information features so as to form an output image.

14. The system of claim 13, wherein the one or more convolution layers belong to a feature extraction part of a framework.

15. The system of claim 13, wherein the multiple residual blocks belong to a reference information generation (RIG) part of a framework.

16. The system of claim 15, wherein the multiple residual blocks include eight residual blocks, wherein the first four residual blocks are used for predicting coding-tree-unit (CTU) partition information from the one or more convolution layers, wherein the RIG part further includes the multiple convolutional layer sets, and wherein each of the multiple convolutional layer sets includes a convolutional layer with stride 2 and a convolutional layer followed by a rectified linear unit (ReLU).

17. The system of claim 13, wherein the different-scales features is processed by dilated convolutional layers based dense blocks with channel attention (DDBCAs) so as to form the combined feature.

18. The system of claim 17, wherein the DDBCAs and the RSABs belong to a mutual information processing (MIP) part of a framework.

19. The system of claim 17, wherein the MIP part includes four scales configured to generating the different-scales features.

20. A method for video processing applied to an encoder, the method comprising:
receiving an input image;
processing the input image by one or more convolution layers;
processing the input image by multiple residual blocks by using partition information of the input image as reference so as to obtain reference information features;
generating different-scales features based on the reference information features;
processing the different-scales features by multiple convolutional layer sets;
processing the different-scales features by reference spatial attention blocks (RSABs) and dilated convolutional layers based dense blocks with channel attention (DDBCAs) so as to form a combined feature; and
concatenating the combined feature with the reference information features so as to form an output image.
